(19) United States
(12) Patent Application Publication
(10) Pub. No.: US 2026/0160926 A1
(43) Pub. Date: Jun. 11, 2026

(54) OPTICAL FILM, POLARIZING PLATE, AND LIQUID CRYSTAL DISPLAY PANEL

(71) Applicant: KANEKA CORPORATION, Osaka (JP)

(72) Inventors: Naoto Kataoka, Osaka (JP); Yoshio Furukawa, Osaka (JP); Aiko Katsura, Osaka (JP)

(73) Assignee: KANEKA CORPORATION, Osaka (JP)

(21) Appl. No.: 19/313,037

(22) Filed: Aug. 28, 2025

Related U.S. Application Data
(63) Continuation-in-part of application No. PCT/JP2024/007034, filed on Feb. 27, 2024.

(30) Foreign Application Priority Data
Feb. 28, 2023 (JP) 2023-030587

(51) Int. Cl. G02B 1/10; G02B 5/30; G02F 1/1335

(52) U.S. Cl. CPC G02B 1/10; G02B 5/305; G02F 1/133528

(57) ABSTRACT

An optical film having an acrylic resin film including an acrylic resin, and an easy-adhesion layer formed on the acrylic resin film is provided. The acrylic resin film has a glass transition temperature of at least 120° C., the sum of kurtosis Rku on both sides of the optical film is 10 to 50, and an internal haze of the optical film is at most 1.0%.

### TECHNICAL FIELD

One or more embodiments of the present invention relates to an optical film, a polarizing plate, and a liquid crystal display panel.

### BACKGROUND

In a liquid crystal display device, two polarizing plates usually are disposed on both sides of a liquid crystal cell. As the polarizing plate, a polarizing plate in which polarizer protective films for protecting a polarizer are bonded to both sides of the polarizer with an adhesive is generally used. A polarizer protective film is required to have high transparency, and optical films made of a cellulose-based material are widely used.

For the purpose of improving durability and the like, it has been proposed to use an optical film made of an acrylic resin or a norbornene-based resin as the polarizer protective film. However, when these optical films are wound as a roll, the films come into contact with each other and wrinkles and wrinkle marks are likely to occur. A method of ensuring roll winding properties by adding fine particles such as silica particles to the norbornene-based resin film has been proposed (Patent Document 1). In addition, it has been proposed to form an easily-adhering layer containing particles of silica or the like on one surface of a film to ensure roll windability (Patent Documents 2 and 3).

### PATENT DOCUMENTS

Patent Document 1: PCT International Publication No. WO2018/074513
Patent Document 2: Japanese Unexamined Patent Application, Publication No. 2007-127893
Patent Document 3: Japanese Unexamined Patent Application, Publication No. 2010-55062

Although the occurrence of wrinkles and wrinkle marks during winding can be addressed by methods like those disclosed in Patent Documents 1 to 3, as the film quality level is improved by a higher definition or a larger area of the liquid crystal display panel, when the film is stored as a film roll, it has become clear by the study of the present inventors that the defects occur due to post-winding tightening during storage. Further, although the present inventors tried to address the above phenomenon by adding silica to an acrylic resin film according to the method described in Patent Document 1, the conventional method was found to be difficult to satisfy the requirements as an optical film, such as an increase in haze.

### SUMMARY

One or more embodiments of the present invention have been made to address the above. One or more embodiments of the present invention are to suppress blocking during film roll storage while maintaining heat resistance and transparency of an optical film.

As a result of intensive studies to address the above, the present inventors have completed one or more embodiments of the present invention.

That is, one or more embodiments of the present invention relate to the following.

[1] An optical film including: an acrylic resin film having an acrylic resin as a main component; and an easily-adhering layer formed on the acrylic resin film, in which a glass transition temperature of the acrylic resin film is 120° C. or higher, a sum of kurtosis Rku of both surfaces of the optical film is 10 or more and 50 or less, and an internal haze is 1.0% or less.

[2] The optical film as described in [1], in which a coefficient of static friction between one surface and the other surface of the optical film is 0.8 or less.

[3] The optical film as described in [1] or [2], in which the sum of ten-point mean roughness Rzjis of both surfaces of the optical film is 0.05 μm or more and 1.0 μm or less.

[4] The optical film as described in any one of [1] to [3], in which the acrylic resin contains at least one ring structure selected from a lactone ring structure, a glutarimide structure, a glutaric anhydride structure, an N-substituted maleimide structure, or a maleic anhydride structure.

[5] The optical film as described any one of [1] to [3], in which the acrylic resin has a triad syndiotacticity of 54% or more.

[6] The optical film as described in any one of [1] to [5], in which the acrylic resin film contains an anti-blocking agent, and the anti-blocking agent contains acrylic crosslinked particles having an average particle diameter of 0.1 μm or more and 2.5 μm or less.

[7] The optical film as described [6], in which the anti-blocking agent includes acrylic crosslinked particles having an average particle diameter of 0.1 μm or more and 2.0 μm or less.

[8] The optical film as described [6] or [7], in which the acrylic resin film contains 0.05 wt % or more and 0.9 wt % or less of the acrylic crosslinked particles.

[9] The optical film as described in any one of [1] to [5], in which the acrylic resin film includes acrylic crosslinked particles having an average particle diameter of 0.1 μm or more and 2.0 μm or less.

[10] The optical film as described in any one of [1] to [9], in which the internal haze is 0.5% or less.

[11] The optical film as described in [10], in which the internal haze is 0.3% or less.

[12] The optical film as described in any one of [1] to [11], in which a haze is 2.0% or less.

[13] The optical film as described in [12], in which the haze is 1.5% or less.

[14] The optical film as described in any one of [1] to [13], in which the optical film has a dimensional change ratio of −2.0% or more and −0.1% or less when left to stand for 120 hours in an atmosphere of 85° C. and 85% RH.

[15] A polarizing plate including the optical film as described in any one of [1] to [14].

[16] A liquid crystal display panel including the polarizing plate as described in [15].

### Effects of the Invention

According to one or more embodiments of the present invention, it is possible to provide an optical film excellent in transparency and heat resistance and capable of preventing blocking during film roll storage.

### DETAILED DESCRIPTION

One or more embodiments of the present invention will be described, but the present invention is not limited thereto. The present invention is not limited to the configurations described below, and various modifications are possible within the scope of the claims. Embodiments and Examples obtained by appropriately combining technical means disclosed in different embodiments and Examples are also included in the technical scope of the present invention. All of the academic literatures and Patent Documents described in the present description are incorporated into the present description by reference. Unless otherwise specified in the present description, “A to B” representing the numerical range means “A or more (including A and greater than A) and B or less (including B and less than B)”, respectively.

### (Optical Films)

An optical film of one or more embodiments is an optical film including: an acrylic resin film containing an acrylic resin as a main component; and an easily-adhering layer formed on the acrylic resin film, in which a glass transition temperature of the acrylic resin film is 120° C. or higher, a sum of kurtosis Rku of both surfaces of the optical film is 10 or more and 50 or less, and an internal haze is 1.0% or less. As described above, an optical film excellent in heat resistance and transparency and also excellent in anti-blocking properties during film roll storage can be obtained by controlling the sum of kurtosis on both surfaces of the film to a predetermined value and further controlling the internal haze to a predetermined value while using an acrylic resin as a main component.

### (Acrylic Resin Films)

The glass transition temperature of the acrylic resin film of one or more embodiments is 120° C. or higher. The temperature may be higher than 120° C., 121° C. or higher, 122° C. or higher, or 123° C. or higher. When the glass transition temperature of the acrylic resin film is 120° C. or higher, the dimensional change ratio of a stretched film in a high-temperature environment becomes small. In practical use, the acrylic resin film of one or more embodiments is often used by being laminated with an easily-adhering layer or another film, and when the dimensional change ratio is small, occurrence of distortion or warping, which is caused by a difference in dimensional change ratios between the acrylic resin film and the other film laminated, can be suppressed.

The glass transition temperature of the acrylic resin constituting the acrylic resin film may be 120° C. or higher, higher than 120° C., 121° C. or higher, 122° C. or higher, or 123° C. or higher.

Here, as the acrylic resin having a glass transition temperature of 120° C. or higher, an acrylic resin having a ring structure in the main chain can be suitably used. Examples of the ring structure include at least one ring structure selected from the group consisting of a glutarimide ring, a lactone ring, maleic anhydride, maleimide, and glutaric anhydride. According to these, heat resistance can be imparted. Inter alia, a glutarimide ring structure is particularly preferable from the viewpoints of ease of production, costs, and quality stability.

The content of the ring structure in the acrylic resin having a glass transition temperature of 120° C. or higher may be in the range of 2% by weight or more and 80% by weight or less. The content of the ring structure within this range is preferable, because both the glass transition temperature and the thickness direction retardation Rth are favorable. The content of the ring structure in the acrylic resin can be calculated by measuring a molar ratio between a target ring structure portion and the other portions using ¹H-NMR and converting the molar ratio into a weight ratio. The acrylic resin having a glass transition temperature of 120° C. or higher is a main component of the acrylic resin film and is contained in a content of more than 50% by weight based on 100% by weight of the acrylic resin film. Inter alia, with respect to 100% by weight of the acrylic resin film, 70% by weight or more is preferable, 80% by weight or more is more preferable, 85% by weight or more is further preferable, and 90% by weight or more is particularly preferable.

As the acrylic resin having a glass transition temperature of 120° C. or higher, an acrylic resin having no ring structure in the main chain may be used.

The optical film of one or more embodiments has an internal haze of 1.0% or less. Above all, the internal haze may be 0.7% or less, 0.5% or less, or 0.3% or less. When the internal haze is 1.0% or less, quality when the optical film is mounted on the liquid crystal panel is improved.

In the present description, the internal haze is defined as a haze value measured by using a haze meter (turbidity meter) with respect to a glass cell in which the obtained film is placed in a glass cell for liquid measurement and pure water is filled around the glass cell.

The haze of the optical film of one or more embodiments is not particularly limited as long as the internal haze is in the above range, but from the viewpoint of transparency, the haze may be 3.0% or less, 2.0% or less, or 1.0% or less.

When the sum of the kurtosis Rku on both sides of the optical film is 10 or more and 50 or less, blocking during storage of the film roll can be effectively prevented. This can prevent defects that may occur in the film. Here, when the sum of the kurtosis Rku of both surfaces of the optical film is less than 10, blocking due to the post-winding tightening occurs during film roll storage, and as a result, film defects occur. This tendency becomes noticeable when a long film roll (for example, 8,000 m) is stored. Therefore, only an optical film with a fixed size (for example, 4,000 m) can be wound, and the yield is lowered. In addition, even in the case of an optical film with a fixed size, since the optical film in the inner side is plastically deformed when the film roll is stored, plastically deformed optical film cannot be used. On the other hand, when the sum of the kurtosis Rku of both surfaces of the optical film is more than 50, the transparency of the optical film is lowered. The sum of the kurtosis Rku of both surfaces of the optical film may be 15 or more and 30 or less. When the sum of the kurtosis is 10 or more, friction between films is easily reduced. In addition, it is presumed that when the film is laid in a roll shape, air entangled between the films easily escapes, blocking due to the post-winding tightening can be suppressed, and film defects can be suppressed. In addition, when the sum of kurtosis is 50 or less, irregular reflection of light on the surface can be suppressed, which can suppress deterioration of clarity of the panel display.

Here, “blocking” means a state in which portions of the film stick to each other, and encompasses a state in which the film portions partially melt at a high temperature and/or a state in which the film portions overlap perfectly on top of each other. When the post-winding tightening occurs, a pressure is applied to the film to cause blocking (sticking) between the film portions, and as a result, when the film portions are peeled off from each other, the film portions are pulled by a strong force, which causes damage to the film. Therefore, by setting the kurtosis of both surfaces of the film to a predetermined range as in one or more embodiments, sticking between portions of the film in the film roll can be suppressed, even when the post-winding tightening occurs, which enables one to peel off the films from each other with a weak force, resulting in suppression of damage (film defect) to the film.

Here, kurtosis Rku is in accordance with JIS B 0601 and can be calculated from a roughness curve. Kurtosis refers to pointedness in a height direction: Rku=3 means that height distribution exhibits normal distribution; Rku>3 means that the surface has sharp mountains and valleys; and Rku<3 means that the surface is flat.

In the optical film, the sum of ten-point mean roughness Rzjis of both surfaces may be 0.05 μm or more and 1.0 μm or less. When the sum of ten-point mean roughness Rzjis of the both surfaces is 0.05 μm or more, friction between the films is easily reduced. In addition, it is presumed that when the film is laid in a roll shape, air entangled between the films easily escapes and blocking due to the post-winding tightening can be suppressed, which can suppress film defects. In addition, when the sum of the ten-point mean roughness Rzjis of both surfaces is 1.0 μm or less, irregular reflection of light on the surface can be suppressed, which can suppress deterioration of the clarity of the panel display. Inter alia, the sum of the ten-point mean roughness Rzjis of both surfaces of the optical film may be 0.05 μm or more and 0.6 μm or less, or 0.05 μm or more and 0.5 μm or less.

When the acrylic resin has a ring structure in the main chain, the sum of ten-point mean roughness Rzjis of both surfaces of the optical film may be 0.10 μm or more and 1.0 μm or less, 0.16 μm or more and less than 1.0 μm, 0.17 μm or more and 0.6 μm or less, or 0.2 μm or more and 0.5 μm or less. The 10-point mean roughness Rzjis of one surface and/or the other surface of the optical film may be more than 0.080 μm and 0.25 μm or less.

On the other hand, in the case where the acrylic resin has no ring structure in the main chain, particularly in the case where the triad syndiotacticity described later is 54% or more, the sum of ten-point mean roughness Rzjis of both surfaces of the optical film may be 0.05 μm or more and 1.0 μm or less, 0.06 μm or more and less than 0.60 μm, 0.06 μm or more and less than 0.50 μm, 0.06 μm or more and 0.40 μm or less, or 0.07 μm or more and 0.30 μm or less. The 10-point mean roughness Rzjis of one surface and/or the other surface of the optical film may be more than 0.020 μm and 0.20 μm or less.

Kurtosis Rku and Rzjis (surface roughness) of the film can be measured using an optical surface roughness such as a laser microscope. Since a value of the surface roughness of the optical film of one or more embodiments is smaller than the resolution of a laser microscope, sufficient measurement accuracy cannot be obtained with a lens having a small numerical aperture. Therefore, in the present description, a value measured using a lens having a numerical aperture of 0.95 or more is used.

As for the surface roughness of the film, it is preferable to add an anti-blocking agent described later to the acrylic resin from the viewpoint of economic efficiency and environmental burden. Inter alia, organic fine particles are preferable from the viewpoint of affinity with an acrylic resin and dispersibility, and acrylic crosslinked particles are most preferable from the viewpoint of easy control of haze.

The static friction coefficient of the optical film may be 0.8 or less, 0.7 or less, 0.6 or less, or 0.5 or less when measured in a state in which one surface of the film is laid on the other surface of the film. When the static friction coefficient is 0.8 or less, blocking between the films in the film roll can be effectively suppressed. The lower limit of the static friction coefficient is not particularly limited, but may be 0.2 or more from the viewpoint of winding misalignment and meandering during production.

When the optical film is left to stand for 120 hours in an atmosphere of 85° C. and 85% RH, the film may have a dimensional change ratio of −2.0% or more, −1.7% or more, or −1.5% or more as an average value of the dimensional change ratio of the film longitudinal direction (MD direction) and that of the width direction (TD direction). When the dimensional change ratio is −2.0% or more, shrinkage over time during storage of the film roll is suppressed, the stability over time of the wound appearance is improved, and warping and dimensional change when the optical film is bonded to the polarizer are alleviated, so that reduction in contrast and peripheral unevenness of the liquid crystal display device can be suppressed. The dimensional change ratio may be, for example, −0.1% or less. With the dimensional change ratio being −0.1% or less, even when the optical film is bonded to a polarizer and the polarizer itself shrinks, the optical film easily follows the shrinkage. Here, the dimensional change ratio when the optical film is left to stand in an atmosphere of 85° C. and 85% RH for 120 hours can be measured by measuring the dimensional change before and after the optical film is left to stand in an environmental tester set at 85° C. and 85% RH for 120 hours using a three-dimensional measuring instrument.

In the present description and claims, the dimensional change ratio refers to a change ratio of a hole spacing of a 90 mm×90 mm film before and after being left to stand under an atmosphere of 85° C. and 85% RH for 120 hours, the hole spacing being a length between holes made at positions of 20 mm diagonally inward from the four corners of the film. Here, the change ratio of the hole spacing means a change ratio of the hole spacing after being left to stand relative to the hole spacing before being left to stand, and is represented by the following formula.

[(Hole spacing after being left to stand)−(hole spacing before being left to stand)]×100/(hole spacing before being left to stand) (A)

The optical film may have a linear expansion coefficient of 80 ppm or less, or 72 ppm or less at 40 to 60° C. When the linear expansion coefficient is 80 ppm or less, shrinkage and expansion of the film due to temperature change during storage and transportation of the roll are suppressed, and the post-winding tightening is unlikely to occur. On the other hand, the lower limit may be 40 ppm or more. In the case where the linear expansion of the film is 40 ppm or more, when the film is laminated on a polarizer, a difference in the linear expansion between the film and other members is small, and thus warping or the like is unlikely to occur.

The linear expansion coefficient can be measured using, for example, a thermomechanical analyzer TMA-4000SA manufactured by Bruker AXS. Specifically, the linear expansion coefficient can be obtained as follows: in a state where a tensile load of 3.1 g is applied to a film cut into 4 mm×20 mm in a nitrogen atmosphere, the temperature of the film is raised at 2° C./min in a temperature range not exceeding the glass transition temperature; a chart is prepared by plotting the temperature on the X-axis and an amount of change in the length of the film on the Y-axis; the slope as the linear expansion coefficient is calculated in the temperature range from 40° C. to 60° C. in the temperature raising and lowering process by the least squares method.

### (Anti-Blocking Agent)

The acrylic resin film may be formed of an acrylic resin composition in which an anti-blocking agent has been added to the acrylic resin. As the anti-blocking agent, acrylic crosslinked particles are preferable from the viewpoint of compatibility with the acrylic resin, dispersibility, and transparency. Any shape can be selected as the shape of the particle, but spherical particles are preferable because the anti-blocking property is easily exhibited.

A refractive index of the anti-blocking agent may be 98% or more and 102% or less, or 99% or more and 101% or less when the refractive index of the acrylic resin is assumed to be 100%. The refractive index of the anti-blocking agent may be 1.47 or more and 1.55 or less, 1.47 or more and 1.53 or less, or 1.48 or more and 1.52 or less. By using an anti-blocking agent having a refractive index in the above range, an acrylic resin film having high transparency can be obtained. Inter alia, the acrylic crosslinked particles are preferable because they satisfy the above refractive index.

The polymerizable monomer for forming the acrylic crosslinked particles can be selected from any (meth)acrylic acid esters and other copolymerizable monomers, and may contain methyl methacrylate from the viewpoint of compatibility with the acrylic resin and refractive index. The content of the structural unit derived from methyl methacrylate in the acrylic crosslinked particles may be 80% by weight or more and 99% by weight or less, or 83% by weight or more and 96% by weight or less. When the content of the structural unit derived from methyl methacrylate in the acrylic resin is high, the content of the structural unit derived from methyl methacrylate in the acrylic crosslinked particles may be high.

The acrylic crosslinked particles further contain, as a polymerizable monomer, a structural unit derived from a polyfunctional monomer containing two or more polymerizable groups in the molecule. The content of the polyfunctional monomer in the polymerizable monomer can be freely set, but may be 0.5% by weight or more and 30% by weight or less. When the content is less than 0.5% by weight, the heat resistance and dispersibility of the acrylic crosslinked particles are poor. When the content is more than 30% by weight, there is a possibility that coalescence of particles and formation of irregularly shaped particles may occur when producing acrylic crosslinked particles.

The average particle diameter of the acrylic crosslinked particles may be 0.1 μm or more and 2.5 μm or less, 0.1 μm or more and 2.1 μm or less, 0.1 μm or more and 2.0 μm or less, 0.3 μm or more and 2.0 μm or less, or 0.5 μm or more and 2.0 μm or less. When the average particle diameter is less than 0.1 μm, it is necessary to increase the addition amount to be able to exhibit the anti-blocking property, and therefore, mechanical properties and economic efficiency may be inferior. When the upper limit is more than 2.5 μm, clogging of the polymer filter may be induced. In addition, from the viewpoint of long-running properties of the polymer filter, it is preferable to use acrylic crosslinked particles having a narrow particle size distribution and a small content of coarse particles.

The addition amount of the acrylic crosslinked particles of one or more embodiments may be 0.05% by weight or more and 0.9% by weight or less, 0.07% by weight or more and 0.5% by weight or less, 0.09% by weight or more and 0.3% by weight or less, or 0.1% by weight or more and 0.2% by weight or less. When the addition amount is less than 0.05% by weight, a sufficient blocking prevention effect cannot be obtained, and when the addition amount is 0.9% by weight or less, deterioration in economic efficiency can be prevented, and an increase in haze can be prevented. In addition, a plurality of types of particles having different particle size distributions may be mixed for the purpose of controlling slipperiness and surface properties. In this case, the addition amount of the acrylic crosslinked particles is the sum of the addition amounts of the plurality of types of particles.

### (Easily-Adhering Layer)

The optical film of one or more embodiments has an easily-adhering layer on the acrylic resin film. The easily-adhering layer is formed on one side or both sides of the acrylic resin film. For example, when the optical film is used as a polarizer protective film, the optical film is bonded to a polarizer via an adhesive. At this time, adhesion between the polarizer protective film and the polarizer by the adhesive can be reinforced by providing an easily-adhering layer. It is also possible to obtain a stretched film having an easily-adhering layer by providing an easily-adhering layer on an unstretched film and then stretching the film.

The easily-adhering layer used in one or more embodiments can be formed using a known technique described in Japanese Unexamined Patent Application, Publication Nos. 2009-193061 and 2010-55062. That is, for example, it can be formed from an easily-adhering adhesive composition containing a urethane resin having a carboxy group and a crosslinking agent. By using the urethane resin, an easily-adhering layer having excellent adhesion between a polarizer protective film and a polarizer can be obtained. The easily-adhering adhesive composition may be a water-born composition from the viewpoint of workability and environmental protection.

### (Acrylic Resin)

As described above, the acrylic resin film has a glass transition temperature of 120° C. or higher, and the acrylic resin having a glass transition temperature of 120° C. or higher can be suitably used as the acrylic resin that can be used as the acrylic resin film. As the acrylic resin having a glass transition temperature of 120° C. or higher, an acrylic resin having a ring structure in the main chain and an acrylic resin not having a ring structure in the main chain can be used, as described above. Each ring structure will be described below.

### (Acrylic Resin Having Glutarimide Ring in Main Chain)

The acrylic resin having a glutarimide ring as the ring structure in the main chain is a resin containing a glutarimide unit represented by the following general formula (1) and a methyl methacrylate unit, and is obtained by heating and melting an acrylic resin having an acrylic ester unit content of less than 1% by weight and treating it with an imidizing agent.

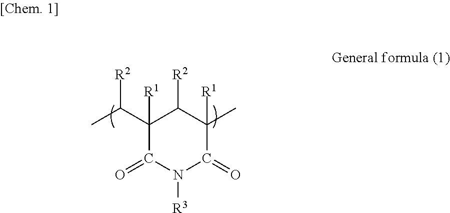

(Here, R¹ and R² each independently represent hydrogen or an alkyl group having 1 to 8 carbon atoms, and R³ represents an alkyl group having 1 to 18 carbon atoms, a cycloalkyl group having 3 to 12 carbon atoms, or an aryl group having 6 to 10 carbon atoms).

The content of the glutarimide ring according to one or more embodiments is, for example, a value that can be measured by the following method. The measurement is performed using ¹H-NMR. A molar ratio is obtained from a peak area around 3.5 ppm to 3.8 ppm derived from O—CH₃ protons of methyl methacrylate and a peak area around 3.0 ppm to 3.3 ppm derived from N—R³ protons of the glutarimide group and the molar ratio is converted into a weight ratio.

In the step of treating with the imidizing agent, in addition to methyl methacrylate, for example, methyl acrylate, ethyl (meth)acrylate, butyl (meth)acrylate, isobutyl (meth)acrylate, t-butyl (meth)acrylate, benzyl (meth)acrylate, cyclohexyl (meth)acrylate, and the like may be used in combination. In the case where these are used in combination, it is preferable that the acrylic ester unit is less than 1% by weight. Furthermore, the content of the acrylic acid ester unit may be less than 0.5% by weight, or less than 0.3% by weight.

In addition to the above monomers, it is also possible to copolymerize a nitrile-based monomer such as acrylonitrile, methacrylonitrile, etc., a maleimide-based monomer such as maleimide, N-methylmaleimide, N-phenylmaleimide, N-cyclohexylmaleimide, etc. and an aromatic vinyl-based monomer such as styrene, etc.

The structure of the methyl methacrylate resin is not particularly limited, and may be any of a linear polymer, a block polymer, a core-shell polymer, a branched polymer, a ladder polymer, a crosslinked polymer, etc.

In the case of the block polymer, any of an A-B type, an A-B-C type, an A-B-A type, and a block polymer other than the above-mentioned types may be used. In the case of the core-shell polymer, it may consist only of a single layered core and a single layered shell, or each may consist of multiple layers.

A method for producing polymethyl methacrylate is not particularly limited, and a known emulsion polymerization method, including an emulsion-suspension polymerization method, a suspension polymerization method, a bulk polymerization method, a solution polymerization method and the like can be applied. However, when used in the optical field, a bulk polymerization method and a solution polymerization method are particularly preferable from the viewpoint that impurities are small. For example, it can be produced according to the method described in Japanese Unexamined Patent Application, Publication Nos. S56-8404, H6-86492, H7-37482, S52-32665, or the like.

The method for producing the acrylic resin of one or more embodiments includes a step of heating and melting a methyl methacrylate resin or an acrylic resin obtained by copolymerizing monomers other than the methyl methacrylate monomer, and treating the melted resin with an imidizing agent (imidizing step). Thus, an acrylic resin having glutarimide can be produced.

The imidizing agent is not particularly limited as long as it can form a glutarimide ring represented by the general formula (1), and examples thereof include those described in WO2005/054311. Examples thereof include aliphatic hydrocarbon group-containing amines such as ammonia, methylamine, n-propylamine, i-propylamine, n-butylamine, i-butylamine, tert-butylamine, n-hexylamine, etc.; aromatic hydrocarbon group-containing amines such as aniline, benzylamine, toluidine, trichloroaniline, etc.; and alicyclic hydrocarbon-containing amines such as cyclohexylamine, etc. In addition, urea-based compounds that generate the exemplified amines by heating, such as urea, 1,3-dimethylurea, 1,3-diethylurea, and 1,3-dipropylurea, also can be used. Among these imidizing agents, methylamine, ammonia, and cyclohexylamine may be used in terms of both costs and physical properties, or methylamine may be used.

Methylamine or the like, which is in a gaseous state at room temperature, may be used in a state of being dissolved in an alcohol such as methanol.

In the imidization step, a ratio of the glutarimide unit and the (meth)acrylic acid ester unit in the acrylic resin to be obtained can be adjusted by adjusting the addition ratio of the imidizing agent.

Further, by adjusting an extent of imidization, physical properties of the acrylic resin to be obtained, transparency of the stretched film to be obtained by molding the acrylic resin according to one or more embodiments, and the like can be adjusted.

An amount of the imidizing agent is 0.5 parts by weight to 20 parts by weight based on 100 parts by weight of the acrylic resin containing a methyl methacrylate unit. When the added amount of the imidizing agent is within this range, the imidizing agent is unlikely to remain in the resin, and the possibility of inducing appearance defects or foaming after molding is extremely low. In addition, the finally obtained resin composition is preferable, because the content of the glutarimide ring in the finally obtained resin composition is appropriate, the heat resistance is less likely to decrease, and appearance defects after molding are less likely to be induced.

In the imidization step, a ring closure accelerator (catalyst) may be added as necessary in addition to the imidizing agent.

The method of heat melting and treating with the imidizing agent is not particularly limited, and any conventionally known method can be used. For example, the acrylic resin containing a methyl methacrylate unit can be imidized by a method using an extruder, a batch-type reaction vessel (pressure vessel), or the like.

The extruder is not particularly limited. For example, a single-screw extruder, a twin-screw extruder, or a multi-screw extruder can be used. The extruder may be used alone, or a plurality of extruders may be used in series. When a twin-screw extruder is used, a non-intermeshing co-rotating type, an intermeshing co-rotating type, a non-intermeshing counter-rotating type, and an intermeshing counter-rotating type may be exemplified. Inter alia, the intermeshing co-rotating type twin-screw extruder is rotatable at a high speed, and therefore can further promote mixing of the raw material polymer and the imidizing agent (when a ring closing accelerator is used, the imidizing agent and the ring closing accelerator).

When imidization is performed in an extruder, for example, an imidization reaction can be caused to proceed in the extruder by charging a methyl methacrylate resin from a raw material feeding port of the extruder, melting the resin to fill the inside of a cylinder, and then injecting the imidizing agent into the extruder using an addition pump.

In this case, the temperature (resin temperature), the time (reaction time), and the resin pressure to be treated in the extruder are not particularly limited as long as glutarimide formation is possible.

When an extruder is used, it is also preferable to install a vent hole capable of reducing the pressure to atmospheric pressure or less in order to remove unreacted imidizing agent and by-products. According to such a configuration, unreacted imidizing agent, by-products such as methanol, and monomers can be removed.

When the acrylic resin containing a glutarimide ring in the main chain is produced using a batch-type reaction vessel (pressure vessel), the structure of the batch-type reaction vessel (pressure vessel) is not particularly limited. A batch-type reaction vessel that can melt the acrylic resin containing a methyl methacrylate unit by heating and can stir it, and has a structure through which an imidizing agent (in the case of using a ring closing accelerator, the imidizing agent and the ring closing accelerator) can be added is satisfactory. The batch-type reaction vessel may have a structure by which good stirring efficiency can be achieved.

Examples of the imidization method include known methods such as the methods disclosed in Japanese Unexamined Patent Application, Publication Nos. 2008-273140 and 2008-274187.

The method for producing the acrylic resin of one or more embodiments may include a step of treatment with an esterification agent, in addition to the imidization step. By this esterification step, an acid value of the imidized resin obtained in the imidization step can be adjusted within a desired range.

The esterifying agent is not particularly limited as long as it can esterify a carboxy group remaining in the molecular chain. Examples thereof include dimethyl carbonate, 2,2-dimethoxypropane, dimethyl sulfoxide, triethyl orthoformate, trimethyl orthoacetate, trimethyl orthoformate, diphenyl carbonate, dimethyl sulfate, methyl toluenesulfonate, methyl trifluoromethylsulfonate, methyl acetate, methanol, ethanol, methyl isocyanate, p-chlorophenyl isocyanate, dimethyl carbodiimide, etc. Among these, dimethyl carbonate and trimethyl orthoacetate are preferable from the viewpoint of costs, reactivity, and the like, and dimethyl carbonate is preferable from the viewpoint of costs.

In this imidization step, an amount of the esterifying agent may be 0 to 30 parts by weight, or 0 to 15 parts by weight, based on 100 parts by weight of the acrylic resin containing a methyl methacrylate unit. When the esterifying agent is in these ranges, the acid value can be adjusted to an appropriate range. On the other hand, when the amount is more than this range, unreacted esterification agent may remain in the resin, which may cause foaming or odor generation when molding is performed using the obtained resin.

In addition to the esterifying agent, a catalyst may be used in combination. The catalyst is not particularly limited as long as it can promote esterification. Examples thereof include aliphatic tertiary amines such as trimethylamine, triethylamine, and tributylamine. Among these, triethylamine is preferable from the viewpoint of costs, reactivity, and the like.

In this esterification step, only heat treatment or the like can be performed without treatment with an esterification agent. In the case where only the heat treatment (kneading, dispersion, or the like of a molten resin in the extruder) is performed, a part or all of the carboxy groups may be converted into an acid anhydride group(s) by a dehydration reaction between a carboxy group in the acrylic resin having a glutarimide ring produced as a by-product in the imidization step or a dealcoholization reaction between a carboxy group and an alkyloxycarbonyl group. At this time, a ring closure accelerator (catalyst) may be used. Even in the case where treatment with an esterifying agent is performed, conversion of carboxy groups into an acid anhydride group(s) by heat treatment is also possible.

Since an imide resin subjected to the imidization step and the esterification step contains an unreacted imidization agent, an unreacted esterification agent, a volatile component produced as a by-product by the reaction, a resin decomposition product, and the like, a vent hole capable of reducing the pressure to atmospheric pressure or less may be installed.

### (Acrylic Resin Having Lactone Ring in Main Chain)

The acrylic resin having a lactone ring as a ring structure in the main chain is not particularly limited as long as it is a thermoplastic polymer having a lactone ring structure in the molecule (thermoplastic polymer in which a lactone ring structure is introduced in the molecular chain), and the production method thereof is also not particularly limited. However, it is preferable that a polymer (a) having a hydroxy group and an ester group in the molecular chain is obtained by polymerization (polymerization step), and thereafter, the obtained polymer (a) is heat-treated to introduce a lactone ring structure into the polymer (lactone cyclization condensation step).

In the polymerization step, a polymer having a hydroxy group and an ester group in the molecular chain is obtained by carrying out a polymerization reaction of a monomer component containing an unsaturated monomer represented by the following general formula (2).

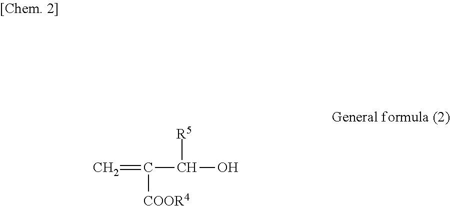

(Here, R⁴ and R⁵ each independently represent a hydrogen atom or an alkyl group having 1 to 20 carbon atoms).

Examples of the unsaturated monomer represented by the general formula (2) include methyl 2-(hydroxymethyl)acrylate, ethyl 2-(hydroxymethyl)acrylate, isopropyl 2-(hydroxymethyl)acrylate, normal butyl 2-(hydroxymethyl)acrylate, tert-butyl 2-(hydroxymethyl)acrylate, etc. Among these, methyl 2-(hydroxymethyl)acrylate and ethyl 2-(hydroxymethyl)acrylate are preferable, and methyl 2-(hydroxymethyl)acrylate is particularly preferable in the point of being highly effective in improving heat resistance. These unsaturated monomers may be used alone or in combination of two or more types thereof.

The content of the unsaturated monomer represented by the general formula (2) in the monomer component may be 5 wt to 50 wt %, 10 wt % to 40 wt %, or 10 wt % to 30 wt %. When the content is less than 5% by weight, heat resistance, solvent resistance, and surface hardness of the obtained lactone ring-containing polymer may be lowered. When the content is more than 50% by weight, a crosslinking reaction occurs when forming the lactone structure and gelation easily occurs. This lowers fluidity and makes it difficult to melt and mold the lactone ring-containing polymer, in some cases. Further, since unreacted hydroxy groups are likely to remain, a condensation reaction further progresses and a volatile substance is generated during molding, so that a silver streak is likely to occur and thickness direction retardation Rth may increase.

The monomer component may contain another monomer in addition to the unsaturated monomer represented by the general formula (2). The other monomer is not particularly limited as long as it is selected within a range that does not impair the effects of one or more embodiments of the present invention, and examples thereof include (meth)acrylic acid esters, hydroxy group-containing monomers, unsaturated carboxylic acids, and unsaturated monomers represented by the following general formula (3). The other monomer may be used alone or in combination of two or more types thereof.

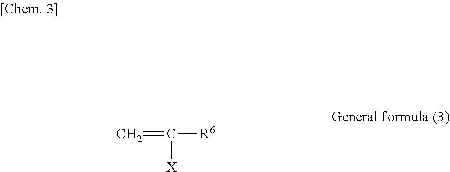

(Here, R⁶ represents a hydrogen atom or a methyl group, X represents a hydrogen atom, an alkyl group having 1 to 20 carbon atoms, an aryl group, an —OAc group, a —CN group, or a —CO—R⁷ group. The Ac group represents an acetyl group, and R⁷ represents a hydrogen atom or an alkyl group having 1 to 20 carbon atoms.)

The (meth)acrylic acid ester is not particularly limited as long as it is a (meth)acrylic acid ester other than the unsaturated monomer represented by the general formula (2), and examples thereof include acrylic acid esters such as methyl acrylate, ethyl acrylate, n-butyl acrylate, isobutyl acrylate, t-butyl acrylate, cyclohexyl acrylate, and benzyl acrylate; methacrylic acid esters such as methyl methacrylate, ethyl methacrylate, propyl methacrylate, n-butyl methacrylate, isobutyl methacrylate, t-butyl methacrylate, cyclohexyl methacrylate, benzyl methacrylate, etc. These may be used alone or in combination of two or more types thereof. Inter alia, methyl methacrylate is particularly preferable from the viewpoints of heat resistance and transparency.

When the (meth)acrylic acid ester is used, the content of the ester in the monomer component may be from 10% by weight to 95% by weight, from 10% by weight to 90% by weight, from 40% by weight to 90% by weight, or from 50% by weight to 90% by weight, from the viewpoint of sufficiently exhibiting the effects of one or more embodiments of the present invention.

### (Acrylic Resin Having Maleic Anhydride, Maleimide and Glutaric Anhydride Structure in Main Chain)

In one or more embodiments, it is also preferable to use an acrylic resin having a maleimide or glutaric anhydride structure as the ring structure in the main chain. Examples of the maleic anhydride structure include a styrene-N-phenylmaleimide-maleic anhydride copolymer. Examples of the maleimide structure include olefin-maleimide copolymers as described in Japanese Unexamined Patent Application, Publication No. 2004-45893. Examples of the glutaric anhydride structure include copolymers having a glutaric anhydride unit as described in Japanese Unexamined Patent Application, Publication No. 2003-137937.

### (Acrylic Resin not Having Ring Structure in Main Chain)

Examples of the acrylic resin having a glass transition temperature of 120° C. or higher include a method of introducing a carboxy group such as methacrylic acid. When the amount of the carboxy group is equal to or more than a certain amount, a risk of a crosslinked product being formed arises or a risk of foaming during film formation increases, and therefore, it is preferable to suppress the amount to a certain amount or less. Specifically, the amount of carboxy groups in the acrylic resin may be 0.6 mmol/g or less, or 0.4 mmol/g or less.

As the acrylic resin having a glass transition temperature of 120° C. or higher, an acrylic resin having a triad syndiotacticity of 54% or more can be suitably used. When the triad syndiotacticity of the acrylic resin is 54% or more, the glass transition temperature of the acrylic resin becomes high, and the heat resistance of the acrylic resin tends to be improved. The triad syndiotacticity of the acrylic resin may be 55% or more, 56% or more, or 57% or more. In addition, the triad syndiotacticity of the acrylic resin may be 67% or less, 65% or less, or 63% or less from the viewpoints of the molding temperature of the acrylic resin, the toughness of the molded article, and secondary processability.

Triad syndiotacticity of an acrylic resin refers to a ratio that successive chains of three structural units (triad) are rr. Note that in the successive chain of two structural units (diad), a diad having the same configuration is referred to as meso (m), and a diad having a reversed configuration is referred to as racemo (r).

A method for synthesizing the acrylic resin having a triad syndiotacticity of 54% or more is not particularly limited, and examples thereof include an anionic polymerization method and a radical polymerization method. Among these, the radical polymerization method is preferable (see, e.g., International Publication Nos. WO2023/238885 and WO2023/238886). In the radical polymerization method, since an organometallic compound as a polymerization initiator and/or an organic solvent as a medium which are/is used in the anionic polymerization method, are/is not used, impurities hardly remain. This is preferable from the viewpoint of the environmental aspect. Here, the glass transition temperature and triad syndiotacticity of an acrylic resin can be controlled by polymerization temperature of the acrylic resin. For example, when the polymerization temperature of the acrylic resin is lowered, the glass transition temperature of the acrylic resin increases, and the syndiotacticity of the acrylic resin increases. The glass transition temperature of an acrylic resin can also be controlled by the molecular weight of the acrylic resin.

The content of a structural unit derived from methyl methacrylate in the acrylic resin having a triad syndiotacticity of 54% or more may be 98% by weight or more, 99% by weight or more, or 100% by weight.

The monomer other than methyl methacrylate constituting the acrylic resin having a triad syndiotacticity of 54% or more is not particularly limited, and examples thereof include alkyl acrylate esters such as methyl acrylate, ethyl acrylate, propyl acrylate, butyl acrylate, 2-ethylhexyl acrylate, etc.; aryl acrylates, such as phenyl acrylate, etc.; cycloalkyl alkylates, such as cyclohexyl acrylate, norbornenyl acrylate, etc.; alkyl methacrylates other than methyl methacrylate, such as ethyl methacrylate, propyl methacrylate, butyl methacrylate, etc.; aryl methacrylate esters such as phenyl methacrylate, etc.; cycloalkyl methacrylate esters such as cyclohexyl methacrylate, norbornenyl methacrylate, etc.; aromatic vinyl compounds such as styrene, α-methylstyrene, etc.; acrylamides; methacrylamides; acrylonitrile; and methacrylonitrile.

### (Other Characteristics of Acrylic Resins)

Hereinafter, other characteristics of the acrylic resin having a ring structure in the main chain and the acrylic resin not having a ring structure in the main chain will be described. Hereinafter, the term “acrylic resin” means at least one of an acrylic resin having a ring structure in the main chain or an acrylic resin not having a ring structure in the main chain.

The weight average molecular weight of the acrylic resin may be 50,000 or more and 200,000 or less, or 90,000 or more and 150,000 or less. When the weight average molecular weight of the acrylic resin is 50,000 or more, the mechanical properties of the molded article of the acrylic resin tend to be improved, and when the weight average molecular weight of the acrylic resin is 200,000 or less, the moldability of the acrylic resin tends to be improved.

The weight average molecular weight of the acrylic resin may be 400,000 or more. When the weight average molecular weight of the acrylic resin is 400,000 or more, the mechanical properties of the molded article of the acrylic resin tend to be further improved, and for example, a resin film excellent in bending resistance can be obtained. In this case, the weight average molecular weight of the acrylic resin may be 600,000 or more, 700,000 or more, or 800,000 or more. The weight average molecular weight of the acrylic resin may be 2.5 million or less, 2 million or less, 1.5 million or less, or 1.2 million or less, from the viewpoint of moldability of the acrylic resin.

A ratio (dispersity) of a weight average molecular weight to a number average molecular weight of an acrylic resin may be 1.6 or more and 2.5 or less, or 1.7 or more and 2.2 or less. When the dispersity of an acrylic resin is 1.6 or more, the flowability of the acrylic resin tends to be improved to facilitate molding, and when the dispersity of the acrylic resin is 2.5 or less, the mechanical properties such as impact resistance, toughness, and bending resistance of the molded article of the acrylic resin tend to be improved.

The number average molecular weight and the weight average molecular weight of the acrylic resin are values in terms of standard polystyrene measured by gel permeation chromatography (GPC). The number average molecular weight and the weight average molecular weight of the acrylic resin can be controlled by the types and used amounts of a polymerization initiator and a chain transfer agent used in synthesizing the acrylic resin.

### (Acrylic Resin Composition)

As the acrylic resin film, an acrylic resin composition obtained by adding an additive to an acrylic resin may be used, and an anti-blocking agent and an additive may be used in combination. As the additives, generally used antioxidants, heat stabilizers, light stabilizers, ultraviolet absorbers, specific wavelength absorbers or specific wavelength absorbing dyes for the purpose of blue light cut, light resistance stabilizers such as radical scavengers, phase difference adjusting agents, catalysts, plasticizers, lubricants, antistatic agents, colorants, shrinkage inhibitors, antibacterial and/or deodorizing agents, fluorescent brighteners, compatibilizers, and the like may be added alone or in combination within the range that does not impair the effect of one or more embodiments of the present invention.

Examples of the ultraviolet absorbers include triazine-based compounds, benzotriazole-based compounds, benzophenone-based compounds, cyanoacrylate-based compounds, benzoxazine-based compounds, oxadiazole-based compounds, etc. Among these, triazine-based compounds are preferable from the viewpoints of ultraviolet absorption performance for the added amount, and volatility when melt extrusion is performed.

With regard to the phase difference adjusting agents, when a negative phase difference is imparted, a compound having a styrene skeleton is satisfactory. An acrylonitrile-styrene copolymer is exemplified.

A method for mixing the acrylic resin and the anti-blocking agent is not particularly limited, and any conventionally known methods can be used. Examples thereof include a method of supplying the acrylic resin and the anti-blocking agent to an extruder using a gravimetric feeder and melt-kneading them, a method of mixing the acrylic resin and the anti-blocking agent in the form of a solution using a solvent excellent in compatibility with both the acrylic resin and the anti-blocking agent, or the like.

When mixing is performed using an extruder, the extruder to be used is not particularly limited, and various extruders can be used. Specifically, a single-screw extruder, a twin-screw extruder, a multi-screw extruder, or the like can be used. Among them, a twin-screw extruder may be used. According to the twin-screw extruder, the degree of freedom of conditions for uniformly mixing the acrylic resin and the anti-blocking agent is wide. In addition, the acrylic resin and the anti-blocking agent may be fed and mixed from the upstream side of the extruder using a raw material feeding hopper or the like, or only the anti-blocking agent may be fed and mixed from the middle of the extruder using a side feeder, a gravimetric feeder, or the like. Alternatively, the anti-blocking agent may be formed into a masterbatch in advance in a separate extruder to use the masterbatch.

A filter may be also installed at the end of the extruder for the purpose of reducing a foreign matter in the resin. A gear pump may be provided in front of the filter in order to increase the pressure of the acrylic resin/acrylic resin composition (A). As the type of the filter, it is preferable to use a stainless-steel leaf disk filter capable of removing a foreign matter from a molten polymer, and it is preferable to use a fiber type, a powder type, or a composite type thereof as a filter element.

### (Method for Producing Optical Films)

One or more embodiments of the method for producing an optical film of one or more embodiments of the present invention will be described, but the present invention is not limited thereto. That is, any conventionally known method can be used as long as a film can be produced by molding the acrylic resin composition of one or more embodiments.

Examples thereof include injection molding, melt extrusion molding, inflation molding, blow molding, compression molding, etc. In addition, the film according to one or more embodiments can be manufactured by a solution casting method or a spin coating method in which the acrylic resin composition according to one or more embodiments is dissolved in a solvent that can dissolve it and then molding is performed.

Inter alia, a melt extrusion method that does not use a solvent may be used. The melt extrusion method, can reduce burden on the global environment and the working environment incurred by manufacturing costs and/or solvents.

When molding the acrylic resin composition of one or more embodiments into a film by the melt extrusion method, first, the acrylic resin composition of one or more embodiments is pre-dried, then fed to an extruder, and is heated and melted. Further, it is supplied to a die such as a T-die through a gear pump or a filter. Next, the acrylic resin composition supplied to the T die is extruded as a sheet-shaped molten resin and cooled and solidified using a cooling roll, etc. to obtain an unstretched film (also referred to as a raw film). At this time, in order to improve surface properties (smoothness) of the film, the film may be sandwiched between a metal roll and a flexible roll provided with a metal elastic outer cylinder.

When molding the acrylic resin composition of one or more embodiments into an unstretched film by the solution casting method, the acrylic resin composition of one or more embodiments is made into a solution together with an organic solvent, and then the solution is cast on a support and heated and dried to produce an unstretched film. The solvent that can be used in the solution casting method may be selected from known solvents. Halogenated hydrocarbon solvents such as methylene chloride, trichloroethane, etc. are preferable solvents because they easily dissolve the acrylic resin of one or more embodiments and also have a low boiling point. A highly polar non-halogen solvent such as dimethylformamide, dimethylacetamide, etc. can also be used. Further, aromatic solvents such as toluene, xylene, anisole, etc., cyclic ether solvents such as dioxane, dioxolane, tetrahydrofuran, pyran, etc., and ketone-based solvents such as methyl ethyl ketone, etc. can also be used. These solvents may be used alone. Alternatively, a mixture of a plurality of types may be used. An amount of the solvent to be used may be any amount as long as the thermoplastic resin can be dissolved to such an extent that casting can be sufficiently performed. In the present description, “dissolved” means that the resin is present in the solvent in a uniform state so that casting can be sufficiently performed. It is not necessary that the solute be completely dissolved in the solvent. A concentration of the resin in the solution may be 1 wt % to 90 wt %, 5 wt % to 70 wt %, or 10 wt % to 50 wt %. As a preferable support, an endless belt made of stainless-steel may be used. Alternatively, a film such as a polyimide film or a polyethylene terephthalate film also can be used.

The optical film of one or more embodiments is obtained by stretching the unstretched film (also referred to as a raw film). By stretching the unstretched film, a stretched film having a desired thickness can be produced, and further, mechanical properties of the stretched film can be improved. As a stretching method, conventionally known methods can be used. For example, an unstretched raw film formed by melt extrusion may be uniaxially or biaxially stretched to produce a film having a predetermined thickness. In order to impart excellent mechanical properties to both the longitudinal direction (MD direction) and the width direction (TD direction) of the stretched film, biaxial stretching is preferable. The biaxial stretching method may be simultaneous biaxial stretching or sequential biaxial stretching.

The stretching ratio (in the case of biaxial stretching, both the stretching ratio in the MD direction and the stretching ratio in the TD direction of the film) may be 1.5 times to 3.0 times, or 1.8 times to 2.8 times. When the stretching ratio is within this range, the mechanical properties of the film accompanied by stretching can be sufficiently improved. In addition, the degree of orientation does not increase too much, the dimensional change when left to stand for 120 hours in an atmosphere of 85° C. and 85% RH can be reduced, and the possibility that the peel strength decreases when bonded to a polarizer is also low. The stretching speed may be 1.1 times/min or more, or 5 times/min or more. In addition, it may be 100 times/min or less, or 50 times/min or less. In the case of sequential biaxial stretching, the stretching speed of the first step and the stretching speed of the second step may be the same or different. In the sequential biaxial stretching, the stretching in the first step is generally the stretching in the longitudinal direction (MD direction), and the stretching in the second step is the stretching in the width direction (TD direction).

The stretching temperature is not particularly limited, but may be Tg+7° C. to Tg+50° C., or Tg+10° C. to Tg+40° C. When the stretching temperature is equal to or higher than Tg+7° C., risk of breakage in the stretching step can be suppressed. On the other hand, when the stretching temperature is equal to or lower than Tg+50° C., sufficient molecular orientation can be obtained, and a decrease in mechanical strength of the film can be suppressed. When the stretching temperature is within the above range, the molecular orientation is relaxed, whereby the mechanical strength is lowered, while the dimensional change in the atmosphere of 85° C. and 85% RH is reduced. In addition, in the case of a film containing an anti-blocking agent, when the film is stretched at a low temperature, particles are likely to float on the surface, and the surface roughness, the slipperiness, and the external haze are likely to be expressed. Those skilled in the art can freely set stretching conditions in consideration of the above balance.

The optical film of one or more embodiments is wound into a roll by a known method. According to the film of one or more embodiments, even when the film width is increased or the winding length is increased, defects due to blocking between the films are less likely to occur. In addition, it is more effective to combine a knurling process, etc., which has been conventionally used as a countermeasure against blocking, for end portions.

### (Applications)

When the optical film of one or more embodiments is used as a polarizer protective film, it is bonded to a polarizer to form a polarizing plate. The polarizer is not particularly limited, and any conventionally known polarizer can be used. For example, a polarizer obtained by adding iodine to stretched polyvinyl alcohol may be used.

The polarizing plate is further bonded to various films, and can be suitably used in, for example, display fields such as a liquid crystal display, an organic EL display, etc. However, the application is not limited thereto.

### EXAMPLES

One or more embodiments of the present invention will be described more specifically based on Examples and Comparative Examples, but the present invention is not limited thereto. Those skilled in the art are allowed to make various changes, modifications, and revisions to one or more embodiments of the present invention, without departing from the scope of the invention.

### (Surface Roughness)

The surface roughness of the optical film was measured using a laser microscope LEXT OLS5100 manufactured by Evident Co., Ltd. in accordance with JIS B0601:2013. Specifically, first, a confocal image in a range of 257 μm×257 μm of the film was captured by using an objective lens having a magnification of 50 times and a numerical aperture of 0.95. Then, three evaluation lines were drawn at equal intervals in each of the MD direction and the TD direction to extract roughness curves. From each of the obtained roughness curves, 10-point mean roughness Rzjis and Kurtosis Rku were calculated by analysis software, and the average value at the measurement position was calculated. The measurement was performed five times at different measurement positions, and the average value thereof was adopted as the surface roughness. However, when a partial abnormality such as a scratch was clearly recognized from the image, the partial abnormality was not included in the measurement value, and the measurement was performed again while avoiding the abnormal portion.

### (Static Friction Coefficient)

In accordance with JIS K7125:1999, the static friction coefficient of the optical film was measured using a digital force gauge ZTS-5N and a friction coefficient measuring jig COF-2N-V manufactured by Imada Co., Ltd. Specifically, a surface A of the film was fixed on a smooth stainless-steel plate, a surface B of the film was bonded to a 60×60 mm thread having a weight of 200 g with a double-sided tape, and the load when the thread was moved at a speed of 100 mm/min via a pulley was read by a load cell to calculate the static friction coefficient. The measurement was performed five times by changing the film pieces, and the average value was calculated.

### (Haze and Internal Haze)

The haze of the optical film was measured using a haze meter NDH2000 manufactured by Nippon Denshoku Industries in accordance with JIS 7136:2000. In addition, the optical film was placed in a glass cell for liquid measurement, distilled water was brought into contact with both surfaces of the optical film, and the internal haze of the optical film was measured.

### (Glass Transition Temperature)

The glass transition temperature of the acrylic resin or acrylic resin film was measured using 10 mg of the acrylic resin or acrylic resin composition. Specifically, using a differential scanning calorimeter (DSC7000X, manufactured by Hitachi High-Technologies Corporation), the temperature was risen at a temperature raising rate of 20° C./min in a nitrogen atmosphere, and the glass transition temperature was determined by a midpoint method.

### (Dimensional Change Ratio)

The optical film was cut out to a size of 90 mm×90 mm by using a cutter, and holes were made at positions of 20 mm diagonally inward from the four corners of the film by using a punch with a diameter of 1 mm, and spacings between holes were measured by using MF201 type three-dimensional measuring instrument manufactured by Mitsutoyo. Subsequently, the film whose hole spacings had been measured was left to stand for 120 hours in an LH-20 type environmental testing machine manufactured by Nagano Science set at 85° C. and 85% RH, and then the hole spacings were measured again. Dimensional change ratios were calculated from the differences between the hole spacings before and after being left to stand in 85° C. and 85% RH atmosphere, using the formula (A).

### (Refractive Indexes of Acrylic Resin Composition and Acrylic Crosslinked Particles)

First, the refractive index of the acrylic resin composition was determined as follows in accordance with JIS K7142:2014. Specifically, the acrylic resin composition was melt-pressed at 240° C. to obtain a film having a thickness of 100 μm, and the refractive index (wavelength: 589 nm) of the obtained film was measured under a condition of 23° C. using a refractive index meter (Digital Abbe refractometer DR-M2, manufactured by Atago Corporation). The obtained refractive index was used as the refractive index of the acrylic resin composition.

Next, mixed solutions each containing a halogen-based high refractive index liquid and a low refractive index liquid such as methanol in different ratios were prepared and the refractive indexes of acrylic cross-linked particles were determined in accordance with the following method. Here, upon dispersing acrylic crosslinked particles in one of the mixed solutions, when the refractive index of the mixed solution and the refractive index of the acrylic crosslinked particles do not coincide with each other, a white turbid dispersion liquid is obtained, and when the refractive index of the mixed solution and the refractive index of the acrylic crosslinked particles coincide with each other, a transparent liquid is obtained. For this reason, the refractive index of the mixed solution which formed a transparent solution was used as the refractive index of the acrylic crosslinked particle.

### <Production of Acrylic Resin>

### (Production Example of Acrylic Resin 1)

The extruder used was an intermeshing co-rotating twin-screw extruder (L/D=90) with a bore diameter of 40 mm. The set temperature of each temperature control zone of the extruder was 250 to 280° C., and the screw rotation speed was 85 rpm. After a methyl methacrylate resin was melted by a kneading block to fill the kneading block, 1.8 parts by weight of monomethylamine (manufactured by Mitsubishi Gas Chemical Co., Ltd.) was injected from a nozzle with respect to 100 parts by weight of the methyl methacrylate resin. The resin discharged as a strand from a die provided at the outlet of the extruder was cooled in a water bath and pelletized in a pelletizer to obtain a resin (I). Next, the set temperature of each temperature control zone of the extruder was set to 240 to 260° C. in an intermeshing co-rotating twin-screw extruder having a bore diameter of 40 mm. Dimethyl carbonate (0.56 parts by weight) was injected from a nozzle to 100 parts by weight of the methyl methacrylate resin to reduce carboxy groups in the resin. After the reaction, by-products and excess dimethyl carbonate were removed. The resin exiting as a strand from a die provided at the outlet of the extruder was cooled in a water bath and pelletized in a pelletizer to obtain an acrylic resin 1 having a glutarimide ring. The glass transition temperature of the acrylic resin 1 was 123° C., Mw was 81,000, and Mw/Mn was 1.59.

### (Calculation of Concentration of Ring Structure)

The thus obtained acrylic resin was measured using ¹H-NMR BRUKER Avance III (400 MHz). Weight conversion was performed based on a molar ratio of the target ring structure portion to the other portions. Specifically, in the case of glutarimide, a molar ratio was obtained from a peak area A around 3.5 to 3.8 ppm derived from O—CH₃ protons of methyl methacrylate and a peak area B around 3.0 to 3.3 ppm derived from N—CH₃ protons, and the molar ratio was converted into a weight ratio. The content of the ring structure was 6% by weight.

### Example 1

A mixture containing the acrylic resin 1 produced in the above-described production example of acrylic resin and 0.1% by weight of acrylic crosslinked particles (MX80H3wT manufactured by Soken Chemical & Engineering Co., Ltd., refractive index: 1.49) having an average particle diameter of 0.8 μm as the anti-blocking agent (AB agent) was kneaded in an intermeshing co-rotating twin-screw extruder (L/D=45) having a bore diameter of 15 mm. The resin discharged as a strand from a die provided at the outlet of the extruder was cooled in a water bath, and then pelletized in a pelletizer to obtain an acrylic resin composition (refractive index: 1.49).

The acrylic resin composition thus obtained was dried at 100° C. for 5 hours, and then sandwiched by touch rolls using an intermeshing co-rotating twin-screw extruder (L/D=45) having a T-die at the outlet of the extruder and a bore diameter of 15 mm, to form a film. The sheet-shaped molten resin extruded from the T die provided at the outlet of the extruder was cooled by a cooling roll to obtain a raw film having a width of 160 mm and a thickness of 160 μm. The glass transition temperature of the raw film was measured according to the above-described method and was found to be 123° C. At this time, a surface in contact with the casting roll was defined as a surface B, and the other surface was defined as a surface A.

Next, the surface B of the raw film (acrylic resin film) was subjected to the following easy-adhesion coating to obtain an optical film.

### (Formation of Easily-Adhering Layer)

One surface of the raw film was subjected to corona discharge treatment (corona discharge electron irradiation amount: 100 W/m²/min). To 100 g of a water-borne urethane resin having carboxy groups (DKS Co., Ltd., trade name: Superflex 210, solid content: 33%), 20 g of a crosslinking agent (Nippon Shokubai Co., Ltd., trade name: Epocros WS700, solid content: 25%) and 15 g of colloidal silica (manufactured by Fuso Chemical Co., Ltd., trade name: PL-3, solid content: 20%) were added and stirred for 3 minutes to obtain an easily-adhering adhesive composition. The obtained easily-adhering adhesive composition was applied to the corona discharge-treated surface of the raw film subjected to the corona discharge treatment, using a bar coater (Rod No. 6). The raw film coated with the easily-adhering adhesive was placed in a hot air dryer (80° C.), and the urethane composition was dried for about 1 minute to obtain an easy-adhesion-treated film having an easily-adhering layer formed thereon.

The obtained easy-adhesion-treated film was subjected to simultaneous biaxial stretching at 145° C. at a stretching ratio of 2 times (longitudinal and transverse) using a biaxial stretching apparatus (IMC-1905) manufactured by Imoto Machinery to prepare a stretched film (optical film).

### (Blocking Test)

After 10 test pieces (optical film) of 100 mm×100 mm were stacked, they were left to stand at 60° C. for 2 hours under a pressure of 1 kg from above. Thereafter, the test pieces were allowed to cool at 23° C. for 1 hour, the state of each of the test pieces was visually confirmed, and the test pieces were peeled off by hand and evaluated according to the following criteria:
1: the test pieces of the film are firmly stuck to each other, and a peeling mark is generated on at least one of the test pieces when they are peeled off;
2: the test pieces of the film are stuck to each other, and a peeling mark is not generated on the test pieces when they are peeled off; and
3: no sticking between the test pieces is observed.

Table 1 shows the evaluation results of Rku, Rzjis, coefficients of static friction, hazes, internal hazes, glass transition temperatures, dimensional change ratios, and blocking tests.

### Example 2

An optical film was obtained in the same manner as in Example 1 except that an acrylic resin composition (refractive index: 1.49) to which 0.2% by weight of the AB agent had been added was used.

### Example 3

An optical film was obtained in the same manner as in Example 1 except that an acrylic resin composition (refractive index: 1.49) to which 0.5% by weight of the AB agent had been added was used.

### Comparative Example 1

An optical film was obtained in the same manner as in Example 1 except that the AB agent had not been added.

### Comparative Example 2

An optical film was obtained in the same manner as in Example 1 except that an acrylic resin composition (refractive index: 1.49) to which 1% by weight of the AB agent had been added was used.

### Comparative Example 3

An optical film was obtained in the same manner as in Example 1 except that parapet HM (manufactured by Kuraray: refractive index 1.49, Tg 118° C., Mw=78,000, Mw/Mn=1.72), which is a PMMA resin not containing a ring structure, was used as the acrylic resin 3 instead of the acrylic resin 1.

TABLE 1

| | | | | | Comparative | Comparative | Comparative |
|---|---|---|---|---|---|---|---|
| | | Example1 | Example2 | Example 3 | Example1 | Example 2 | Example 3 |
| Acrylic resin | | 1 | 1 | 1 | 1 | 1 | 3 |
| AB agent particle diameter(μm) | | 0.8 | 0.8 | 0.8 | — | 0.8 | 0.8 |
| Added amount of AB agent(%) | | 0.1 | 0.2 | 0.5 | — | 1 | 0.1 |
| Easy-adhesion coating | | Surface B | Surface B | Surface B | Surface B | Surface B | Surface B |
| Rku | Surface A | 7.4 | 15.0 | 23.1 | 3.1 | 32.2 | 7.8 |
| | Surface B | 6.3 | 9.6 | 17.8 | 3.2 | 21.0 | 6.7 |
| Sum of Rku of both sides | | 13.7 | 24.5 | 40.9 | 6.4 | 53.2 | 14.5 |
| Rzjis(μm) | Surface A | 0.083 | 0.121 | 0.162 | 0.043 | 0.254 | 0.090 |
| | Surface B | 0.087 | 0.113 | 0.151 | 0.093 | 0.240 | 0.086 |

| | | | | | | |
|---|---|---|---|---|---|---|
| Sum of Rzjis of both sides | 0.170 | 0.234 | 0.313 | 0.136 | 0.494 | 0.176 |
| Static friction coefficient | 0.59 | 0.51 | 0.4 | 0.90 | 0.4 | 0.6 |
| Haze(%) | 0.80 | 1.20 | 1.50 | 0.50 | 2.30 | 0.70 |
| Inner haze(%) | 0.10 | 0.10 | 0.20 | 0.10 | 0.50 | 0.10 |
| Glass transition temperature(° C.) | 123 | 123 | 123 | 123 | 123 | 118 |
| Dimensional change ratio(%) | −1.5 | −1.4 | −1.4 | −1.4 | −1.4 | −2.3 |
| Blocking test | 3 | 3 | 3 | 2 | 3 | 2 |

It can be seen from Table 1 that the optical films of Examples 1 to 3 were excellent in transparency and heat resistance and could prevent blocking during film roll storage. On the other hand, in the optical film of Comparative Example 1, since the sum of the kurtosis Rku on both surfaces was 6.4, blocking during film roll storage could not be prevented. In addition, in the optical film of Comparative Example 2, the sum of the kurtosis Rku on both surfaces was 53.2, and thus the transparency was lowered. Further, since the optical film of Comparative Example 3 had a glass transition temperature of 118° C., the heat resistance was low.

### <Production of Acrylic Resin>

### (Example of Production of Acrylic Resin 2)

150 parts by weight of deionized water, 0.20 parts by weight of calcium triphosphate as a dispersant, 0.0075 parts by weight of sodium α-olefin sulfonate, and 0.30 parts by weight of sodium chloride were charged into a 4-L glass reactor equipped with a stirrer having an H-type stirring blade. Next, in a nitrogen atmosphere while stirring at 250 rpm, 100 parts by weight of methyl methacrylate (MMA), 0.289 parts by weight of n-octylmercaptan as a chain transfer agent, and 0.065 parts by weight of dimethyl 2,2′-azobis(isobutyrate) (manufactured by FUJIFILM Wako Pure Chemical, V-601) as the polymerization initiator were added to the reactor. Next, the liquid temperature in the reactor was raised to 70° C. to start polymerization, and 0.10 parts by weight of calcium triphosphate was added to the reactor 2 hours after the start of polymerization. At this time, an exothermic peak accompanying the gel effect was observed 4 hours and 20 minutes after the start of polymerization. Next, heating was started 7 hours after the start of polymerization, and the liquid temperature in the reactor was raised to 95° C. The conversion rate at 7 hours after the start of polymerization was 93%. Next, 2 hours after the temperature of the liquid in the reactor reached 95° C., the liquid temperature in the reactor was cooled to room temperature, at which point the polymerization was terminated, to thereby obtain an acrylic resin dispersion. The conversion at the end of the polymerization was 99%.

The acrylic resin dispersion was acid-washed with 1 N hydrochloric acid in an amount of 0.1 times the weight of the charged monomer, and then washed with water to remove the dispersant. Next, the washed acrylic resin dispersion was dehydrated and dried to obtain an acrylic resin 2 in a bead shape. The acrylic resin 2 had a glass transition temperature of 120° C., a triad syndiotacticity of 578, Mw of 83,000, Mw/Mn of 1.63, and the content of the structural unit derived from methyl methacrylate of 100% by weight.

### (Conversion Rate)

The conversion rate was obtained from a ratio of a weight of the solid content of the acrylic resin after drying in an oven heated to 150° C. for 30 minutes to a weight of the monomer charged by the gravimetric method, that is, the following formula:

(weight of solid content of acrylic resin)×100/(weight of monomer charged).

### (Triad Syndiotacticity)

A ¹H-NMR spectrum of the acrylic resin was measured in a deuterated chloroform solution at 22° C. for 16 integrations using a nuclear magnetic resonance apparatus (AVANCE III 400 MHz, manufactured by Bruker). Next, an area (X) of a region of 0.60 to 0.95 ppm and an area (Y) of a region of 0.60 to 1.25 ppm when a chemical shift of tetramethylsilane (TMS) is 0 ppm are measured, and then the triad syndiotacticity was obtained from the following formula:

(X/Y)×100.

### (Weight Average Molecular Weight, Number Average Molecular Weight and Dispersity)

The weight average molecular weight (Mw), number average molecular weight (Mn) and dispersity (Mw/Mn) of the acrylic resin were calculated using gel permeation chromatography (GPC). At this time, an analysis was performed under the following conditions using a sample solution prepared by dissolving 20 mg of an acrylic resin in 10 mL of tetrahydrofuran.
Measuring instrument: HLC-8420GPC (manufactured by Tosoh)
Detector: RI detector
Eluent: tetrahydrofuran
Guard column: TSK gel guard column Super H-L (manufactured by Tosoh)
Analysis column: TSK gel Super H5000, Super H4000, Super H3000, and Super H2000 (from Tosoh) (in series)
Eluent flow rate: 0.60 mL/min
Measurement temperature: 40° C.
Standard substance: standard polystyrene (manufactured by Tosoh)

### Example 4

A raw film was obtained in the same manner as in Example 1 except that the acrylic resin 2 was used instead of the acrylic resin 1. The glass transition temperature of the raw film was measured and found to be 121° C.

Next, the surface B of the raw film (acrylic resin-based resin film) was subjected to the following easy-adhesion coating to obtain an optical film.

### (Formation of Easily-Adhering Layer)

One surface of the raw film was subjected to corona discharge treatment (corona discharge electron irradiation amount: 100 W/m²/min). To 3 g of a water-borne urethane resin having carboxy groups (DKS Co., Ltd., trade name: Superflex 210, solid content: 33%), 0.6 g of a crosslinking agent (Nippon Shokubai Co., Ltd., trade name: Epocros WS700, solid content: 25%) and 18.9 g of deionized water were added and stirred for 3 minutes to obtain an easily-adhering adhesive composition. The obtained easily-adhering adhesive composition was applied to the corona discharge-treated surface of the raw film subjected to the corona discharge treatment, using a bar coater (Rod No. 6). The raw film coated with the easily-adhering adhesive was placed in a hot air dryer (80° C.), and the urethane composition was dried for about 1 minute to obtain an easy-adhesion-treated film having an easily-adhering layer formed thereon.

The obtained easy-adhesion-treated film was subjected to simultaneous biaxial stretching at 135° C. at a stretching ratio of 2 times (longitudinal and transverse) using a biaxial stretching apparatus (IMC-1905) manufactured by Imoto Machinery to prepare a stretched film (optical film).

Table 2 shows the evaluation results of Rku, Rzjis, coefficients of static friction, hazes, internal hazes, glass transition temperatures, dimensional change ratios, and blocking tests.

### Example 5

An optical film was obtained in the same manner as in Example 4 except that 0.12% by weight of acrylic crosslinked particles having an average particle diameter of 1.2 μm (J-3PY manufactured by Negami Chemical Industrial, Co., Ltd., refractive index: 1.50) was used instead of 0.1% by weight of acrylic crosslinked particles having an average particle diameter of 0.8 μm. The glass transition temperature of the raw film was measured and found to be 120° C.

### Example 6

An optical film was obtained in the same manner as in Example 4 except that 0.12% by weight of acrylic crosslinked particles having an average particle diameter of 2.2 μm (J-4PY manufactured by Negami Chemical Industrial, Co., Ltd., refractive index: 1.50) was used instead of 0.1% by weight of acrylic crosslinked particles having an average particle diameter of 0.8 μm. The glass transition temperature of the raw film was measured and found to be 120° C.

### Comparative Example 4

An optical film was obtained in the same manner as in Example 4 except that the AB agent had not been added. The glass transition temperature of the raw film was measured and found to be 120° C.

TABLE 2

| | | | | | Comparative |
|---|---|---|---|---|---|
| | | Example 4 | Example 5 | Example 6 | Example 4 |
| Acrylic resin | | 2 | 2 | 2 | 2 |
| AB agent particle diameter(μm) | | 0.8 | 1.2 | 2.2 | — |
| Added amount of AB agent(%) | | 0.1 | 0.12 | 0.12 | — |
| Easy-adhesion coating | | Surface B | Surface B | Surface B | Surface B |
| Rku | Surface A | 21.0 | 22.4 | 23.1 | 3.7 |
| | Surface B | 20.1 | 17.7 | 17.6 | 3.4 |
| Sum of Rku of both sides | | 41.1 | 40.1 | 40.7 | 7.1 |
| Rzjis(μm) | Surface A | 0.043 | 0.056 | 0.076 | 0.016 |
| | Surface B | 0.030 | 0.037 | 0.056 | 0.014 |

| | | | | |
|---|---|---|---|---|
| Sum of Rzjis of both sides | 0.073 | 0.093 | 0.132 | 0.030 |
| Static friction coefficient | 0.61 | 0.62 | 0.48 | 1.89 |
| Haze(%) | 0.52 | 0.81 | 1.01 | 0.18 |
| Inner haze(%) | 0.14 | 0.16 | 0.07 | 0.08 |
| Glass transition temperature(° C.) | 121 | 120 | 120 | 120 |
| Dimensional change ratio(%) | −1.5 | −1.4 | −1.5 | −1.5 |
| Blocking test | 3 | 3 | 3 | 2 |

It can be seen from Table 2 that the optical films of Examples 4 to 6 were excellent in transparency and heat resistance and could prevent blocking during film roll storage. On the other hand, in the optical film of Comparative Example 4, since the sum of the kurtosis Rku on both surfaces was 7.1, blocking during film roll storage could not be prevented.

Although the disclosure has been described with respect to only a limited number of embodiments, those skilled in the art, having benefit of this disclosure, will appreciate that various other embodiments may be devised without departing from the scope of the present disclosure. Accordingly, the scope of the invention should be limited only by the attached claims.

1. An optical film comprising:
an acrylic resin film having an acrylic resin; and
an easily-adhering layer formed on the acrylic resin film,
wherein:
a glass transition temperature of the acrylic resin film is 120° C. or higher,
a sum of kurtosis Rku of both surfaces of the optical film is 10 or more and 50 or less, and
an internal haze of the optical film is 1.0% or less.

2. The optical film according to claim 1, wherein a coefficient of static friction between one surface and another surface of the optical film is 0.8 or less.

3. The optical film according to claim 1, wherein a sum of ten-point mean roughness Rzjis of both surfaces of the optical film is 0.05 μm or more and 1.0 μm or less.

4. The optical film according to claim 1, wherein the acrylic resin comprises at least one ring structure selected from the group consisting of a lactone ring structure, a glutarimide structure, a glutaric anhydride structure, an N-substituted maleimide structure, and a maleic anhydride structure.

5. The optical film according to claim 1, wherein the acrylic resin has a triad syndiotacticity of 54% or more.

6. The optical film according to claim 1, wherein:
the acrylic resin film comprises an anti-blocking agent, and
the anti-blocking c crosslinked particles having an average particle diameter of 0.1 μm or more and 2.5 μm or less.

7. The optical film according to claim 6, wherein the anti-blocking agent comprises acrylic crosslinked particles having an average particle diameter of 0.1 μm or more and 2.0 μm or less.

8. The optical film according to claim 6, wherein the acrylic resin film comprises 0.05 wt % or more and 0.9 wt % or less of the acrylic crosslinked particles.

9. The optical film according to claim 1, wherein the acrylic resin film comprises acrylic crosslinked particles having an average particle diameter of 0.1 μm or more and 2.0 μm or less.

10. The optical film according to claim 1, wherein the internal haze is 0.5% or less.

11. The optical film according to claim 10, wherein the internal haze is 0.3% or less.

12. The optical film according to claim 1, having a haze of 2.0% or less.

13. The optical film according to claim 12, wherein the haze is 1.5% or less.

14. The optical film according to claim 1, wherein the optical film has a dimensional change ratio of −2.0% or more and −0.1% or less after being left to stand for 120 hours in an atmosphere of 85° C. and 85% RH.

15. A polarizing plate comprising the optical film according to claim 1.

16. A liquid crystal display panel comprising the polarizing plate according to claim 15.
